(19) United States
(12) Patent Application Publication
(10) Pub. No.: US 2008/0285987 A1
(43) Pub. Date: Nov. 20, 2008

(54) Electrophotographic Device Utilizing Multiple Laser Sources

(76) Inventors: David John Mickan, Lexington, KY (US); Kevin Dean Schoedinger, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/750,413

(22) Filed: May 18, 2007

(51) Int. Cl. B41J 2/47

(52) U.S. Cl. 399/38

(57) ABSTRACT

An electrophotographic device has first and second laser sources, each controllable to emit a laser beam, a scanning device arranged to direct the beams so as to sweep in a scan direction across a photoconductive surface and a controller configured to control the electrophotographic device. In at least one print mode, the electrophotographic device is controlled such that scan lines written by the first laser beam overlap with scan, lines written by the second laser beam, and a laser power of the first and second laser sources are controlled such that image data corresponding to select print elements are each partially written at a corresponding print element, position along at least two adjacent scan lines so as to combine energy in a manner that forms a synthesized print element on the photoconductive surface at a position between the adjacent scan lines.

### BACKGROUND OF THE INVENTION

The present invention, relates in general to electrophotographic devices, and more particularly, to electrophotographic devices that are capable of utilizing multiple laser sources at two or more image resolutions. The present invention further relates to systems and methods of operating electrophotographic devices utilising multiple laser sources at two or more image resolutions.

In electrophotography, an imaging system forms a latent image by exposing select portions of an electrostatically charged photoconductive surface to laser light. Essentially, the density of the electrostatic charge on the photoconductive surface is altered in areas exposed to a laser beam relative to those areas unexposed to the laser beam. The latent electrostatic image thus created is developed into a visible image by exposing the photoconductive surface to toner, which contains pigment components and thermoplastic components. When so exposed, the toner is attracted to the photoconductive surface in a manner that corresponds to the electrostatic density altered by the laser beam. The toner pattern is subsequently transferred from the photoconductive surface to the surface of a print substrate, such as paper, which has been given an electrostatic charge opposite that of the toner.

A fuser assembly then applies heat and pressure to the toned substrate before the substrate is discharged from the apparatus. Use applied heat causes constituents including the thermoplastic components of the toner to flow into the interstices between the fibers of the medium and the applied pressure promotes settling of the toner constituents in these voids. The toner solidifies as it cools adhering the image to the substrate.

In conventional laser scanning systems, a rotating polygon mirror is used to sweep a laser beam across a photoconductive surface in a scan direction while the photoconductive surface advances in a process direction that, is orthogonal to the scan direction. A scan line is written each time a new facet of the polygon mirror intercepts the laser beam. Moreover, the polygon mirror speed is synchronized with the advancement of the photoconductive surface so as to achieve a desired image resolution, typically expressed in dots per inch (dpi), at a given image transfer rate, typically expressed in pages per minute (ppm).

Slowing the process speed of the photoconductive surface to one half of the full speed image transfer rate without changing the scanning mirror speed provides double scan, line addressability, which can ideally improve the quality of the image printed on the medium due to the increased image resolution capability. Additionally, by operating the photoconductive surface and optionally, the scanning mirror, at half speed, greater time is available for fusing operations because the print medium is moving through the device at a slower speed. Relatively longer fusing times are desirable for example, when the print medium, is relatively thick or where transparencies are used.

However, there are circumstances where it is desirable to increase the image resolution without drastically reducing the image transfer rate, such as where longer fusing operations are not necessary.

Also, some electrophotographic devices utilize a dual laser diode configuration where two scan lines are written across the corresponding photoconductive surface each time a new facet of the polygon mirror intercepts the pair of laser beams. In a typical dual diode configuration, the spacing between the pair of laser diodes is fixed at a predetermined distance, and the polygon mirror speed and image transfer rate are established such that the sweeps of the two beams interleave, essentially providing increased process direction resolution over a single diode configuration at the same polygon mirror speed and image transfer rate. However, with dual diode configurations, double scan line addressability (per laser diode) is generally not achievable using both laser diodes at fall speed image transfer rates due to the limitations of the fixed diode spacing and corresponding system components.

### BRIEF SUMMARY OF THE INVENTION

According to an aspect of the present invention, an electrophotographic device comprises a first laser source controllable to emit a first laser beam, a second laser source controllable to emit a second laser beam, a scanning device and a controller. The scanning device has a plurality of deflecting surfaces arranged to direct the first and second laser beams so as to sweep in a scan direction across a photoconductive surface such that, for each sweep, a scan line written, on the photoconductive surface by the first laser beam is spaced in a process direction that is orthogonal to the scan direction from a scan line written by the second laser beam by a predetermined beam scan spacing. The controller is configured to control the electrophotographic device to provide at least one print mode wherein the electrophotographic device is controlled such that, scan lines written by the first laser beam overlap with scan lines written by the second laser beam and a laser power of the first laser source and a laser power of the second laser source are controlled such that image data for a given print element position is written in adjacent scan lines so as to combine energy in a manner that forms a corresponding synthesized print element on the photoconductive surface at a position between the adjacent scan lines.

According to another aspect of the present invention, a method of controlling an electrophotographic device comprises controlling a first laser source to emit a first laser beam and controlling a second laser source to emit a second laser beam. The method also comprises controlling a scanning device having a plurality of deflecting surfaces arranged to direct the first-aim second laser beams so as to sweep in a scan, direction across a photoconductive surface such that, for each sweep, a scan line written on the photoconductive surface by the first laser beam is spaced in a process direction that is orthogonal to the scan direction from a scan line written by the second laser beam by a predetermined beam scan spacing. The method further comprises providing at least one print mode comprising controlling the electrophotographic device such that scan lines written by the first laser beam overlap with scan lines written by the second laser beam and controlling a laser power of the first laser source and a laser power of the second laser source such that image data for a given print, element position is written in adjacent, scan lines so as to combine energy in a manner that forms a corresponding synthesized print element on the photoconductive surface at a position between the adjacent scan lines.

According to yet another aspect of the present invention, a method of using dual laser sources to write image data to a photoconductive surface comprises assigning at least a first weight and a second weight, each comprising a fraction of a desired full power print element to a first laser source, assigning at least, a first weight and a second weight, each comprising a fraction of said desired full power print element to a second laser source, controlling an imaging operation of an electrophotographic device such that said first and second, laser sources overlap scan lines when writing to a corresponding photoconductive surface and controlling said first and second laser sources such that image data corresponding to select Print elements to be written to said photoconductive surface are each partially written at a corresponding Print element position along at least two adjacent scan lines so as to combine energy in a manner that forms a synthesized print element on said photoconductive surface at a position between said adjacent scan lines.

### BRIEF DESCRIPTION OF THE SEVERAL VIEWS OF THE DRAWINGS

FIG. 1 is a block diagram of an exemplary electrophotographic device;

FIG. 2 is a chart illustrating scan lines written to a photoconductive surface by dual laser sources at a foil speed image transfer rate according to an aspect of the present invention;

FIG. 3 is a diagram representing an exemplary set of scan lines to illustrate various aspects of the present invention;

FIG. 4 is a chart illustrating scan lines written to a photoconductive surface at 1200 dpi according to various aspects of the present invention;

FIG. 5 is a diagram representing an exemplary set of scan lines to illustrate various aspects of the present invention;

FIG. 6 is a diagram representing an exemplary set of scan lines to illustrate various aspects of the present invention;

FIG. 7 is a chart illustrating scan lines written to a photoconductive surface by dual laser sources at a full speed image transfer rate according to various aspects of the present invention;

FIG. 8 is a simplified illustration of synthesizing print elements to realize improved resolution using a dual laser source system according to various aspects of the present invention;

FIGS. 9A-9E illustrate synthesizing print elements to realize improved resolution using a dual laser diode source system according to various aspects of the present invention; and

FIGS. 10A-10E illustrate synthesizing print elements to realize improved resolution using a dual laser diode source system according to various aspects of the present invention.

### DETAILED DESCRIPTION OF THE INVENTION

In the following detailed description of the illustrated embodiments, reference is made to the accompanying drawings that form a part hereof, and in which is shown by way of illustration, and not by way of limitation, specific embodiments in which the invention may be practiced. It is to be understood that other embodiments may be utilized and that changes may be made without departing from the spirit and scope of various embodiments of the present invention.

An Exemplary Electrophotographic Imaging Apparatus

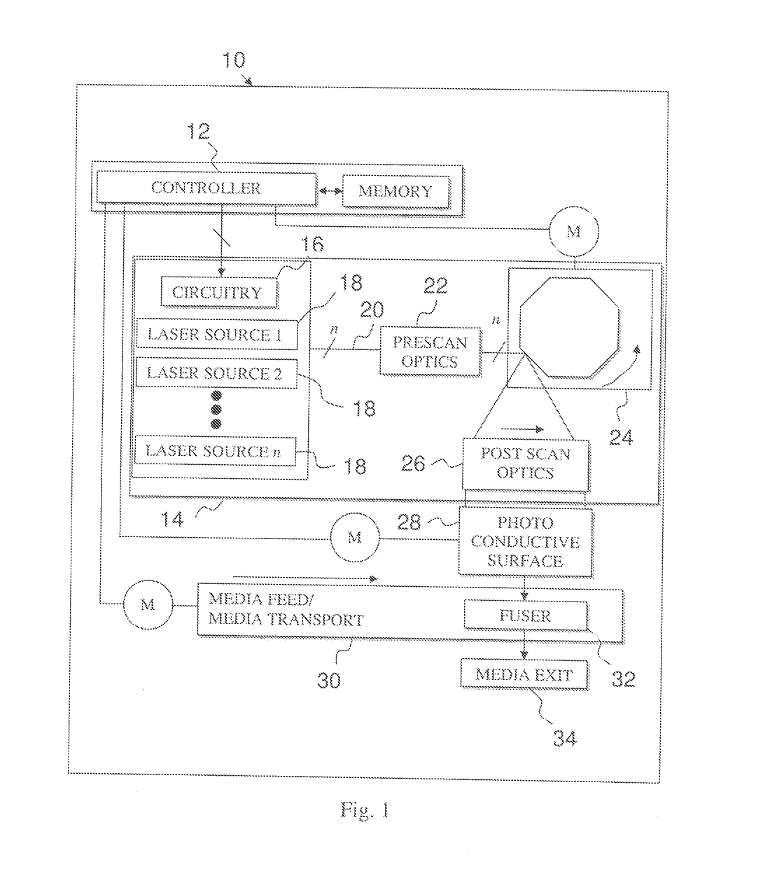

Referring now to the drawings, and particularly to FIG. 1, an apparatus, which is indicated generally by the reference numeral 10, is illustrated for purposes of discussion herein as a monochromatic laser printer. An image to be printed is electronically transmitted to a controller 12 by an external device (not shown). The controller 12 includes and/or is coupled to system, memory, one or more processors such as a raster image processor (RIP) for processing the received image, and other hardware and software logic necessary to control the functions of electrophotographic imaging.

The illustrated apparatus 10 includes a printhead 14 having printhead circuitry 16 and multiple laser sources 18, e.g., laser diodes, which are labeled LASER SOURCE 1 through LASER SOURCE n as shown, where n is any integer greater than 1. The printhead circuitry 16 is communicably coupled to the controller 12 for exchange of laser modulation data and control data between the printhead 14 and the controller 12. For example, control data may be utilized to set and/or vary the laser power used by each laser source 18 to write its corresponding laser modulation data. The overall print quality of the apparatus 10 may be sensitive to the optical output of the laser sources 18. However, optical power requirements are known to vary widely, such as where the laser sources 18 are implemented using laser diodes. For example, optical power requirements may vary as much as 100% or more from laser diode to laser diode. To account for such variations, the printhead circuitry 16 may further include laser driver and power management circuitry for each laser source 18, which may be controlled by the control data communicated from the controller 12.

During an imaging operation, image data corresponding to the image to be printed is converted by the controller 12 into laser modulation data. The controller 12 further initiates an operation whereby the laser modulation data associated with at least one laser source 18 is communicated to the printhead circuitry 16. The laser modulation data is utilized by the laser driver(s) provided in the printhead circuitry 16 to modulate their corresponding laser source 18 so that the printhead 14 outputs one or more modulated laser beams 20, depending upon the number of laser sources 18 utilized for the particular printing operation, as will be described in greater detail herein.

The printhead 14 may former comprise pre-scan optics 22, a scanning device 24 having a plurality of deflecting surfaces, such as a rotating polygon mirror having a plurality of facets and optionally, post scan optics 26. The post scan optics 26 may also and/or alternatively be otherwise provided within the apparatus 10. Each laser beam 20 emitted from its corresponding laser source 18 passes through the pre-scan optics 22 and strikes the polygon mirror. The laser beam(s) 20 are swept by the polygon mirror, pass through post scan optics 26 and are directed to a photoconductive surface 28, e.g., a rotating photoconductive dram or photoconductive belt. During the imaging operation, each modulated laser beam 20 sweeps across the photoconductive surface 28 in a scan direction as the photoconductive surface 28 advances, e.g., rotates. In a process direction.

The main system controller 12 also coordinates the timing of a printing operation to correspond with the imaging operation, whereby a top sheet of a stack of media is picked up, e.g., from a media tray or other media loading configuration, and is delivered to a media transport belt or other appropriate transport arrangement 30. The transport arrangement 30 may carry the sheet past an image forming station comprising the photoconductive surface 28 so as to apply toner to the sheet in pattern corresponding to a latent image written to the photoconductive surface 26. Alternatively, the photoconductive surface 28 may transfer the toned image to an intermediate device such as an electrically conductive intermediate transport belt that subsequently carries the toned image to the sheet.

The transport, arrangement 30 then carries the sheet with the toned image registered thereon to a fuser assembly 32. The fuser assembly 32 includes a nip that applies heat and pressure to adhere the toned image to the sheet. Upon exiting the fuser assembly 32, the sheet may be fed into a duplexing path, for printing on a second surface thereof, or the sheet may be ejected from the apparatus 10 to an output tray. Although FIG. 1 illustrates an exemplary multi-beam printhead and corresponding monochrome apparatus, other configurations may alternatively be implemented, such as for color printing. Moreover, the apparatus may alternatively be implemented in a copier, facsimile machine, multifunction device, etc.

In general, the image transfer rate of the electrophotographic apparatus 10 defines a speed in which a toner image is transferred from the photoconductive surface 28 to an associated image transfer device. As noted above, the image transfer device may comprise for example, an intermediate transfer belt, a transport belt that transports a sheet of print media directly past the photoconductive surface 28, or any other structure for transporting the print media or for transferring the toner patterns from the photoconductive surface 28 to the print media.

Assume that the electrophotographic apparatus 10 has a “facet resolution” that is nominally 300 dpi (118 dots per centimeter) at the full speed image transfer rate. The term “facet resolution” is used herein to denote a process direction resolution, that may be realized by sweeping a single laser beam across the photoconductive surface based upon the current image transfer rate and rotational velocity of the polygon mirror. Thus, using only a single laser beam at the full speed image transfer rate, the facet resolution or process direction resolution realizable is 300 dpi (118 dots per centimeter).

Correspondingly, the term, “facet spacing” is used herein to denote the process direction spacing of a select laser beam on the photoconductive surface as a result of adjacent sweeps, e.g., adjacent facets of the polygon mirror intercepting and sweeping that laser beam. Keeping with the above example, the facet spacing is 1/300th of an inch (84.6 microns) at the foil speed image transfer rate. Without altering the rotational velocity of the polygon mirror, the facet spacing and corresponding facet resolution will change each time the image transfer rate changes because each is dependent. In part, upon the process direction speed of the photoconductive surface 28.

Still further, assume that the printhead 14 comprises two laser sources 18A, 18B that are arranged so as to emit beams 20A, 20B respectively. Moreover, assume that the laser beams 20A and 20B are arranged so as to have a fixed nominal “beam scan spacing” of 3/600th of an inch (approximately 127 microns). As used herein, the term beam scan, spacing refers to the spacing between the scan lines written by the beams 20A and 20B in one sweep, in this instance, the beam scan spacing of 3/600th of an inch (approximately 127 microns) is one and one half times the facet spacing of 1/300th of an inch (84.6 microns). Setting the beam scan spacing to a distance that is not the same as the facet resolution, or an integer multiple thereof avoids a redundancy in beam scans between the laser beams because the beams, e.g., 20A and 20B will interleave as will be described in greater detail herein, in practice, the beam scan spacing can be set to any desired spacing, and may be chosen, for example, to accommodate optics designs and/or video (laser diode modulation data processing) requirements.

Assume the controller 12 is configured for a first operational point (op point) that provides 600 dpi (230 dots per centimeter) printing in the process direction at a fall image transfer rate, e.g., somewhere around 35-50 pages per minute or more. Under this arrangement, the seamier is controlled to rotate at a speed that would realize a facet resolution of 300 dpi (118 dots per centimeter). The actual rotational velocity of the polygon mirror is typically based upon a number of factors, such as the desired image resolution, the number of facets of the polygon mirror and the image transfer rate. As will be seen, because of the beam spacing relative to the scanner resolution, the beam from laser source 18A interlaces with the beam from laser source 18B, resulting in an overall imaging resolution of 600 dpi (236 dots per centimeter).

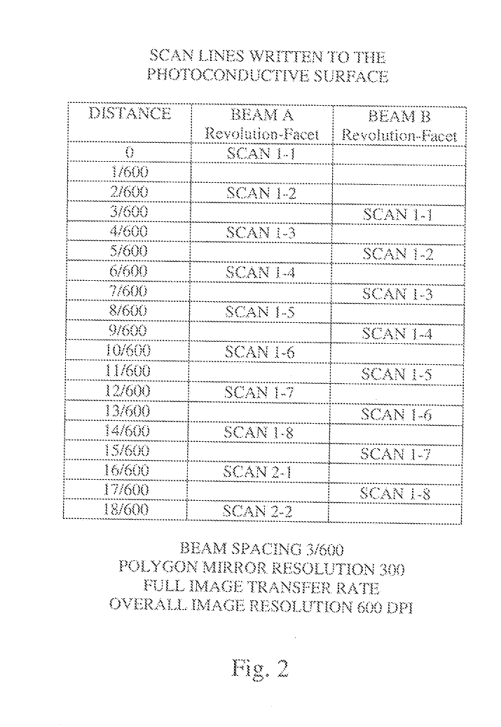

With reference to FIG. 2, a chart illustrates the relative scan positions of two laser beams 20A, 20B written to the photoconductive surface 28 with the above exemplary parameters, i.e., a fixed nominal, beam scan spacing of 3/600th of an inch (approximately 127 microns), where the apparatus is operated at a full speed image transfer rate at a facet resolution of 300 dpi (118 dots per centimeter). The exemplary polygon mirror as shown in FIG. 1 has 8 facets and a scan line is formed each time a facet intercepts the two beams 20A, 20B. Thus, the designation SCAN 1-1 corresponds to the relative process direction position of each beam 20A, 20B when the first facet of the polygon mirror intercepts fire two beams 20A, 20B during a first revolution of the polygon mirror. The designation SCAN 1-2 corresponds to the relative process direction position of each beam 20A, 20B when the second facet of the polygon mirror intercepts the two beams during the first revolution, etc. The designation SCAN 2-1 corresponds to die relative process direction position of each beam 20A, 20B when the first facet of the polygon mirror intercepts the two beams during the second, rotation of the polygon mirror, etc.

As illustrated in the chart, the first laser beam 20A is enabled for modulation in accordance with corresponding image data on every facet of rotation of the polygon mirror. Thus, the first laser beam 20A will scan across the photoconductive surface every 1/300th of an inch (84.6 microns) in the process direction, corresponding to the facet resolution.

Similarly, the second beam 20B is also enabled for modulation in accordance with its corresponding image data on every facet of rotation of the polygon mirror. As such, laser beam 20B will also scan across the photoconductive surface every 1/300th of an inch (84.6 microns) in the process direction (corresponding to the facet resolution). However, because there is a 3/600th of an inch (127 micron) spacing between laser beam 20A and laser beam 20B, the modulated output, of the second laser source 18B will interlace with the modulated output of the first laser source IRA. This interlacing results in an effective scanning resolution by the combination of laser beams 20A, 20B of 600 dpi (236 dots per centimeters) in the process direction.

Also, because the beam scan spacing ( 3/600th of an inch or 12 microns) is greater than the facet spacing ( 1/300th of art inch or 84.6 microns), there will be no scan line at 1/600th of an inch (42.3 micron) from the first scan line. As such, the controller 12, e.g., via the RIP processor, will have to account for the beam scan spacing, for example, by buffering the conversion of image data, to laser modulation data, by disabling the first laser beam for the first facet, etc. Moreover, the timing of the printing operation may require adjustment to accommodate for the offset induced due to the beam scan spacing if necessary. Thus, on the first facet, corresponding to SCAN 1-1 the first laser beam 20A may write no image data, and the second beam 20B may be modulated via suitable laser modulation data to write the second scan line of image data to the photoconductive surface 28. Under this arrangement, at facet 2, i.e., SCAN 1-2, the first laser beam 20A is modulated via suitable laser modulation data to write the first scan line of image data, and the second laser beam 20B is modulated via suitable laser modulation data to write the fourth scan line of image data, etc. This process continues for each facet until the entire image is written to the photoconductive surface 28.

Adjustments, including for example, scan line adjustments, imaging operation adjustments and printing operation adjustments, may not be necessary, such as where the beam scan spacing is alternatively fixed at a distance that is less than the facet spacing, e.g., 1/600th of an inch (42.3 micron) compared to the exemplary 3/600th of an inch or 127 microns in the current illustrative example.

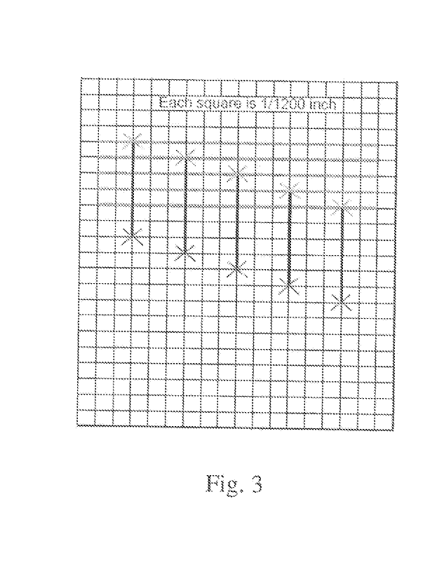

Referring to FIG. 3, it may be desired to double the image resolution, such as for double scan turn addressability. A 1200×1200 dpi grid illustrates the scan line spacing by forming a top X (corresponding to laser beam 20A) and a bottom X (corresponding to laser beam. 20B) connected by a solid line to represent that the scan line written by each beam 20A, 20B occurs in the same sweep, spaced by the fixed beam scan, spacing ( 3/600th of an inch or 127 microns). The process speed is also adjusted so that 1200 dpi (472 dots per centimeter) output resolution is realized. On the 7th scan line, the top laser beam 20A is scanning on file same line that the bottom laser beam 20B scanned on the 1^{st} scan hue. This occurs because the spacing of the two laser beams 20A, 20B remains fixed at 3/600ths of an inch or ( 6/1200ths of an inch or 127 microns). In this example, since both lasers scan the same line there is no need to use them both. Thus, the top laser beam 20A may be enabled and the bottom laser beam 20B may be disabled, or vice versa.

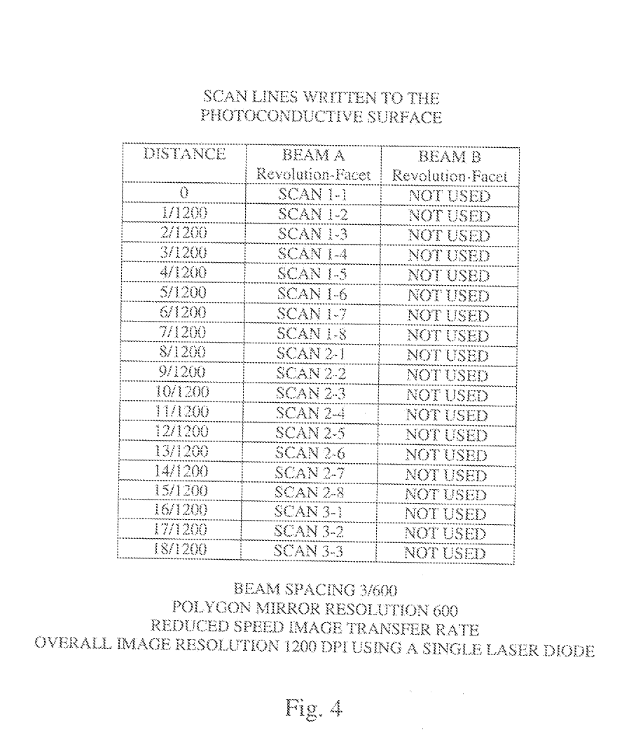

Referring to FIG. 4, a chart illustrates the relative scan positions of two laser beams 20A, 20B written to the photoconductive surface 28 for the exemplary 1200 dpi (472 dots per centimeter) output resolution prim mode illustrated in FIG. 3.

To achieve the desired resolution, the controller 12 may adjust the apparatus 10 based upon a second operational point, such as to adjust the image transfer rate, the polygon mirror speed, or a combination of the two. As an example, if the image transfer rate is reduced to one quarter of the full speed image transfer rate, such as by slowing down a photoconductive drum motor by an appropriate amount, and leaving all other parameters the same, the effective process direction resolution is 1200 dpi (472 dots per centimeter).

Alternatively, a combination of changes to the image transfer rate and polygon mirror velocity may be implemented. For example, if die image transfer rate is reduced to half of the foil speed image transfer rate, such as by slowing down a photoconductive drum motor by an appropriate amount and leaving all other parameters the same, the effective process direction resolution essentially doubles that of the process direction resolution when operating at the lull speed image transfer rate. This is because the photoconductive surface is now moving in the process direction at half the speed that it was moving in the foil image transfer rate. Thus, for example, if the full speed image transfer rate is 35 pages per minute, then by slowing down the image transfer rate to approximately 18 pages per minute, double line addressability may be realized.

To realize the desired 1200 dpi (472 dots per centimeter) resolution under this arrangement, the velocity of the polygon mirror may also be correspondingly increased, such as to 600 dpi (236 dots per centimeter). Changing the rotational velocity of the polygon mirror to 600 dpi (236 clots per centimeter), and slowing the image transfer rate, e.g., to ½ the full, speed image transfer rate allows the apparatus to operate at the desired 1200 dpi (472 dots per centimeter) output resolution. However, as noted above, the scan lines written by each laser source 18A, 18B now overlap instead of interlace because the fixed beam scan spacing of 3/600th of an inch (12 microns). Thus, only one laser source need be used. For example, as indicated with reference to FIG. 4, the second laser source 18B, may be turned off as indicated by the designation “NOT USED”.

The controller 12 is not required to use exactly one half bill image transfer rate and double the polygon mirror motor velocity, but may set any practical to point that meets the imaging requirements. For example, due to factors such as the practical limits on the range of control of the polygon mirror, relatively large variations in polygon motor velocity may not be realizable without affecting print qualify, such as by causing jitter and otherwise unstable or inconsistent rotational velocity. Correspondingly, it may not be practical to rely upon relatively large variations in controlling the velocity of the photoconductive surface for similar reasons.

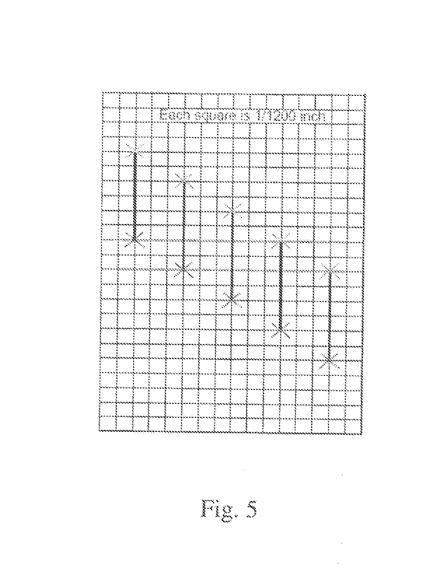

There may be circumstances where high speed/high resolution output is desired. Referring to FIG. 5 in comparison with FIG. 3, assume again that the facet resolution has been increased to 600 dpi. Utilizing both laser sources 18A, 18B is insufficient to realize 1200 dpi (472 dots per centimeter) resolution at the full speed image transfer rate because both laser beams 20A, 20B will eventually sweep across the same scan lines due to the fixed beam scan spacing of 3/600th of an inch (12 microns). Thus, the scan lines would be written at a 600 dpi (236 dots per centimeter). For example. FIG. 5 illustrates that the first scan line written by die second laser beam 20B and the fourth scan line written by the first laser beam 20A overlap. This overlapping persists down the remainder of the image.

Pel Synthesis to Realize Increased Printed Image Resolution

According to aspects of the present invention, another print mode offers higher printed image resolutions while retaining relatively higher image transfer rates without modifying the beam scan spacing. In the present example, 1200×1200 image data at the controller 12 can be converted into laser modulation data in combination with Pel synthesis to achieve true 1200 dpi quality at relatively taster speeds with a dual diode design that would otherwise only realize 600 dpi output resolution. The operation of Pel synthesis is further set out in U.S. Pat. No. 6,229,555 to the same assignee, which is hereby incorporated by reference in its entirety herein.

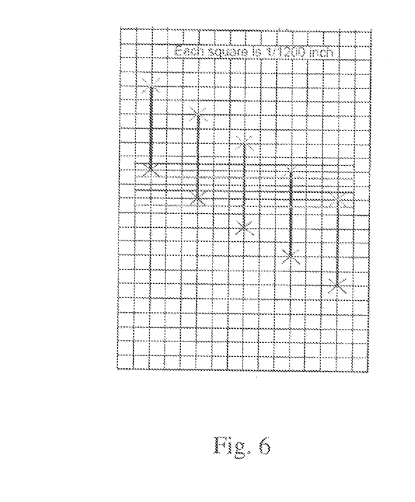

Referring to FIG. 6, keeping with the same exemplary apparatus, i.e., fixed beam scan, spacing of 3/600th of an inch (127 microns), the spacing of print elements formed on the photoconductive surface may be synthetically altered, e.g., to some odd multiple of 1/1200th of an inch (21.2 micron). That is, with Pel synthesis the effective position of a line of resultant latent image data on the photoconductive surface 28 can be repositioned up or down from where a natural, scan line actually sweeps across die photoconductive surface 28. In an illustrative example, the realized, print element positions on the photoconductive surface are altered e.g., by 1/2400th of an inch (10.6 micron). In practice. Pel synthesis may be utilized, to position print elements by other desired spacing.

For example, given a pair of adjacent scan lines, if the top line of the pair of adjacent scan lines is shifted down, by 1/2400th of an inch (1.0.0 micron) and the bottom line of the adjacent pair of scan lines is shifted up by 1/2400th of an inch (10.6 microns), it appears foam the perspective of the photoconductive surface 28, that the beam scan spacing, which is faxed, at 3/600th of an inch ( 6/1200th) (127 microns), effectively becomes 5/1200ths of an inch (106 microns) after the synthesized lines are formed on the photoconductive surface.

In the illustrative example shown in FIG. 6, a first synthetic scan line or lane may be realized 1/2400th of an inch (10.6 micron) above where a corresponding sweep of die second laser beam 20B is centered and a second synthetic scan line or lane may be realized 1/2400th of an inch (10.6 micron) below where a corresponding sweep of the first laser beam 20A is centered. The result is an image where synthetic scan lines are realized on 1200 dpi (21.2 micron) centers.

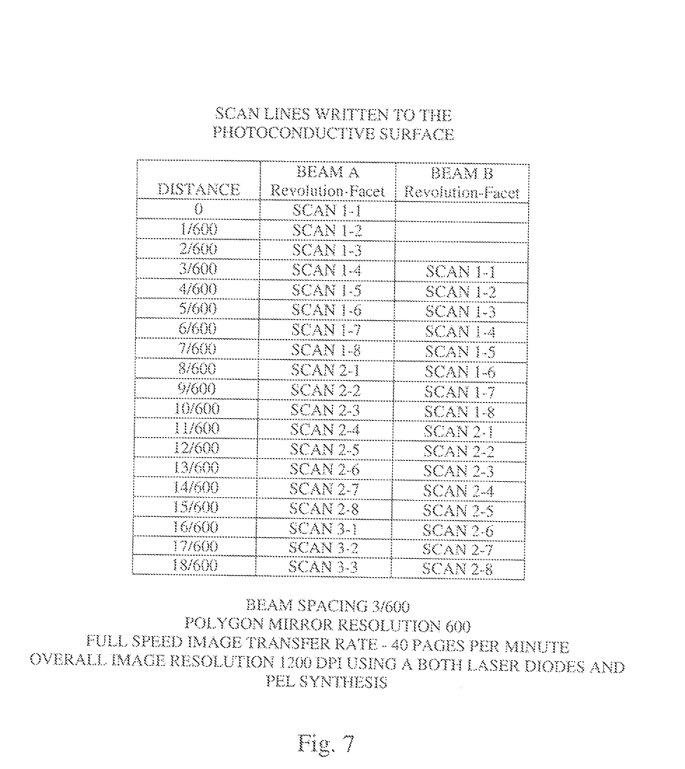

Referring to FIG. 7, in an illustrative example, the beam spacing remains per the previous examples, e.g., at 3/600th of an inch (127 microns). The facet resolution is 600 dpi. However, instead of turning one laser source off both laser sources are utilized. As illustrated in the table, based upon, the beam spacing and the scanner resolution, the beams will overlap in the scan direction. However, as will be described in greater detail below, Pel synthesis is used to position select print element positions to alter the overall output resolution.

As used herein, “print element position” refers to the position along a given scan line corresponding to a given print element. For example, at 600 dpi (42.3) resolution in the scan direction, and priming on a letter sized media, there may be approximately 5100 possible print element locations, which are ideally evenly spaced, across the scan line. Each print element location corresponds to a “print element position”.

Moreover, by “Pel synthesis”, it is meant that a synthesized print element results on the photoconductive surface 28 from a composite of a first initial print, element on a first natural scan, line of an adjacent pair of scan lines and a second initial print element formed on a second natural scan line of the adjacent pair of scan lines, where the first and second initial prim elements are positioned in the same print element position, and are thus ideally in substantial alignment in the process direction.

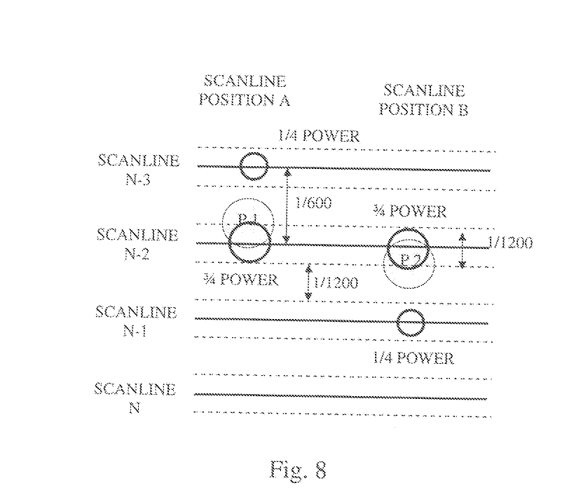

Referring to FIG. 8, natural scan lines N-3, N-2, N-1 and N are shown at a resolution of 600 dpi. For sake of illustration, only two print elements P1 and P2 are shown. Also, in this example, the corresponding electrophotographic device is controlled, e.g., by controlling an imaging operation, such that scan lines written by the first laser source 18A overlap with scan lines written by the second laser source 18B. Keeping with the exemplary electrophotographic device described more fully herein with reference to FIGS. 1-7, i.e., fixed beam scan spacing of 3/600th of an inch (127 microns), this corresponds to a prim mode where the spacing between adjacent scan lines is such that the beam scan spacing is an integer multiple of the spacing between adjacent natural scan, lines. At least one other print mode may also be provided where the beam scan, spacing is not an integer multiple of the spacing between adjacent scan lines, e.g., by utilizing a facet resolution of 300 dpi. However, this example will focus on the print mode having a facet resolution of 600 dpi.

In this example, a laser power of the first laser source 18A and a laser power of the second laser source 18B are controlled such that image data for a given print element position is written by two adjacent, scan line sweeps. The energy written to the photoconductive surface 28 in the two adjacent sweeps at the given print element position combine energy in a manner that forms a corresponding synthesized print element on the photoconductive surface 28 at a positron between the adjacent scan lines.

Moreover, die laser power of the first laser beam 20A and the laser power of the second laser beam 20B may be weighted such that the combined energy corresponding to each synthesized print element corresponds to a desired laser power. In the illustrative example, only a single print element is written in one of two synthesized lanes between, natural scan lines. As shown in FIG. 8, the non-shaded circles represent the energy needed to be written on a scan-by-scan basis to create the effective shaded full weight energy print elements on the 1200 dpi boundary.

In the illustrative example, on scan line N-3, a portion of the total energy required to synthesize prim element P1 is written to the photoconductive surface 28 at print element position A where “A” is an arbitrary position along scan direction. For example, ¼ of the total energy required by P1 may be written to the photoconductive surface 28. On scan line N-2, the remainder of the energy required for print element P1, e.g., ¾ of the required energy, is written to the photoconductive surface 28 at print element position A.

Similarly, on scan line N-2, a portion of the total energy required to synthesize print element P2, e.g., ¾ of the required energy, is written to the photoconductive surface 28 at print element position P1 where “B” is an arbitrary position along scan direction. On scan line N-I, the remainder of the energy required for print element P2, e.g. ¼ of the required energy, is written to the photoconductive surface 28 at print element position B.

At the first print element position A, a synthesized print element P1 is realized that is positioned between scan line N-3 and scan line N-2, which combines the weighted energy of its corresponding “natural” ¾ energy print element and ¼ energy print element to realize a full power print element P1. In the exemplary arrangement, the scan spacing is 1/600th of an inch (42.3 micron) and the synthesized print element P1 is shifted up from scan line N2 by an amount approximately equal to 1/2400th of an inch (10.6 micron). Accordingly, this is referred to herein as positioning P1 into an “upper lane” of scan line N-2.

At the second print element position B, a synthesized print element P2 is realized that is positioned between scan line N-2 and scan line N-1, which combines die weighted energy of its corresponding “natural” ¾ energy print element and ¼ energy print element to realize a fad power print element P2.

In the exemplary arrangement, the scan spacing is 1/600th of an inch (42.3 micron) and the synthesized print element P2 is shifted down from scan line N2 by an amount approximately equal to 1/2400th of an inch (10.6 micron). Accordingly, this is referred to herein as positioning P2 into a “lower lane” of scan line N-2.

Also, in the exemplary arrangement, the scan, spacing is 1/600th of an inch (42.3 micron) corresponding to 600 dpi resolution. However, the first and second synthesized positions, e.g., the upper and lower lanes, are selected so as to achieve double the image resolution of what is otherwise achieved by natural adjacent scan lines. For example, by selecting the upper lane to be 1/2400th of an inch (10.6 micron) above a corresponding natural scan line and by selecting the lower lane to be /2400th of an inch (10.6 micron) below the corresponding natural scan line, a resultant spacing between print elements P1 and P2 is 1200 dpi, which is double the image resolution of the 600 dpi “natural” scan lines.

In the example with regard to FIG. 8, a laser power of the first laser source 18A and a laser power of the second laser source 18B are controlled such that image data corresponding to select print elements, e.g., print elements P1 and P2, are each partially written at a corresponding print element position along at least two adjacent scan lines so as to combine energy in a manner that forms a synthesized print element on a photoconductive surface at a position between said adjacent scan lines. According to various aspects of the present invention, any suitable combination of laser sources 18A, 18B may be utilized to synthesize the prim elements, e.g., P1, P2 into their respective synthesized positions.

For example, each synthesized print element may be written by a select one of the first and second laser sources 18A, 18B. As an illustration of this arrangement, laser source 18A may be utilized, to write the ¼ and ¾ (or other suitably determined weights in adjacent natural scan lines at the corresponding print element position necessary to position print elements into the upper lane of a corresponding natural scan line, and laser source 18B may be utilized to write the ¾ and ¼ (or other suitably determined) weights in adjacent natural scan lines at the corresponding print element position necessary to position, print elements into the lower lane of a corresponding natural scan line.

As another example, each synthesized prim element may be written by the combined energy of the first and second laser sources 18A, 18B. As an illustration of this arrangement, laser source 18A may be utilized to write the ¾ (or other suitably determined) weight and laser source 18B may be utilized to write the ¼ (or other suitably determined) weight in adjacent natural scan lines at the corresponding print element position to position a given synthetic prim element in an intended synthesized position.

According to various aspects of the present invention, any number of power combinations may be employed when utilizing two or more laser sources for addressing each scan line. Moreover, for each print element position, each laser source may be modulated ON or OFF. Still further, each laser source drat is modulated ON at a given print element position may be modulated at one of any number of different weights.

Using Pel synthesis to establish synthesized print element positions on the photoconductive surface requires two natural scan lines for each line of image data. As such, the controller 12 must accommodate adding an extra line of data when converting the image to be printed into the laser modulation data. Moreover, because there is a fixed 3/600th of an inch (127 micron) beam scan spacing, scan line 4 of laser source A overlaps with scan line 1 of laser source B in the present example. As such, the image data for each laser source 18A and 18B must be adjusted to accommodate this characteristic. Corresponding adjustments may also be required, e.g., depending upon the beam scan spacing, output resolution, etc., of the particular implementation.

There are a number of ways that the power of the laser sources can be adjusted. For example, the spot power of the laser beam can be adjusted to accommodate the corresponding weighting(s). Alternatively (or in combination with adjusting the spot power), the size of the weighted print elements can be adjusted.

For example, the laser sources may be controlled by a laser control signal that establishes the desired laser output power. As an example, the controller 12 may be operable to set and/or modify a pulse width modulation (PWM) output signal (Lpow), which is utilized to establish an input control voltage to laser driver circuitry provided as part of the printhead electronics circuitry 16. The controller 12 may alternatively use representations other than PWM signals to adjust a laser power signal. As yet another example, the laser controller may utilize a digital to analog converter (DAC) to adjust laser output power based upon, multi-bit data.

The characteristics of the laser source may be a bruiting factor in the range of adjustment capable of the laser source. For example, a typical laser source such as a laser diode has a limited range of output power. Moreover, the laser driver circuit may have a limited adjustable input voltage control range.

Thus, the laser power may alternatively be adjusted by reducing/enlarging as appropriate, the spot size of a written print element. For example, each prim element may be represented by a laser modulation signal that comprises a plurality of “slices”. Each slice may represent that the corresponding laser source is either modulated on or off in a given written print element, each slice that represents an on state causes the laser diode to modulate on and each slice that represents an off state causes the laser source to be modulated off. When pel synthesis is turned on, it is possible to write low weight energy print elements (e.g., 2/6 slices ON) or high weight energy (e.g., 4/6 slices ON) in addition to full weight energy (e.g., 6/6 slices ON), or any other desired combination of ON and OFF slices. Also, each print element may be subdivided into any number of “slices”.

Pel synthesis allows sub-process direction resolution adjustments to be performed. As noted above however, in Pel synthesis, one or more synthesized positions, also referred to herein as lanes, are defined between adjacent “natural” scan positions. For example, as noted in the example described with reference to FIG. 8, a synthesized lane may be realized, above and below each “natural” scan line. During operation, the total energy of two adjacent print elements in the process direction will combine into a “synthetic” print element on one of the two lanes. Thus, when a high weight energy print element is written, e.g., on for 4/6 slices, or a low weight energy print element is written, e.g., on for 2/6 slices, those energies will synthesize with an adjacent scan line to form a single print element such that the synthesized print elements have generally uniform energy.

Using these principles, the position of the center of the synthesized print element can be varied, at least in part, based upon an amount of difference between the power of laser beams during the formation of initial print elements, in this regard, the power can be varied based upon the spot power, the shape and/or size of the beams. Thus, synthesized print positions spaced at sub pixel vertical (process direction) distances are synthesized by dividing the laser power between two consecutive scan lines.

Moreover, while described with reference to creating two lanes or synthesized positions between two adjacent natural scan lines, the number of lanes and/or the spacing between adjacent natural scan lines may be varied depending upon the desired image characteristics and the system components.

The above-described Pel synthesis process may be used to generate, for example, two synthesized positions (and no natural positions) between each pair of laser scan lines for the entire image. Alternatively, the above-described Pel synthesis process may be used for vertical edge print elements where vertical, interior print elements are imaged at lull nominal power in natural scan lines. As yet another example, to write a print element in a natural lane, the print element may be written by either laser source at full power, and to position a print element into a synthetic lane, the synthetic print element may be written using the techniques as set out more fully herein.

Further, using symmetric power levels may insure that dot density is the same for the synthesized positions, which is useful for generating half toned prints. The technique of using two synthesized positions, described in the above example, gives vertical correction roughly equivalent to using 1200 dpi scan lines on a 600 dpi printer.

As a more detailed example, keeping with the same exemplary apparatus, i.e., fixed beam scan spacing of 3/600th of an inch (127 microns) and a facet resolution of 600 dpi (236 dots per centimeter), the spacing of print elements may be controlled to realize full 1200 dpi resolution by utilizing some basic modifications to the above-described Pel synthesis approach. The corresponding electrophotographic device is controlled such that scan lines written by the first laser source 18A overlap with scan lines written by the second laser source 1 SB so as to realize 600 dpi (236 dots per centimeter) natural scan lines.

As in the above example described with reference to FIG. 5, in order to write a print element in the upper lane above a given natural scan line, ¼ of the total energy required for the print element is written into a first natural scan line adjacent to and preceding the given natural scan line, and ¾ of the total energy required for the print element is written, into the given natural scan line so that the energies from the two natural scan lines synthesize into a single print element positioned along a synthesized scan line (lane) between the adjacent natural scan lines. Correspondingly, in order to write a print element in the lower lane below a given natural scan line, ¾ of the total energy required for the print element is written into the given natural scan line and ¼ of the total energy required for the print element is written into an adjacent, subsequent natural scan line so that the energies from the two natural scan lines synthesize into a single print element positioned along a synthesized scan line (lane) between, the adjacent natural scan lines.

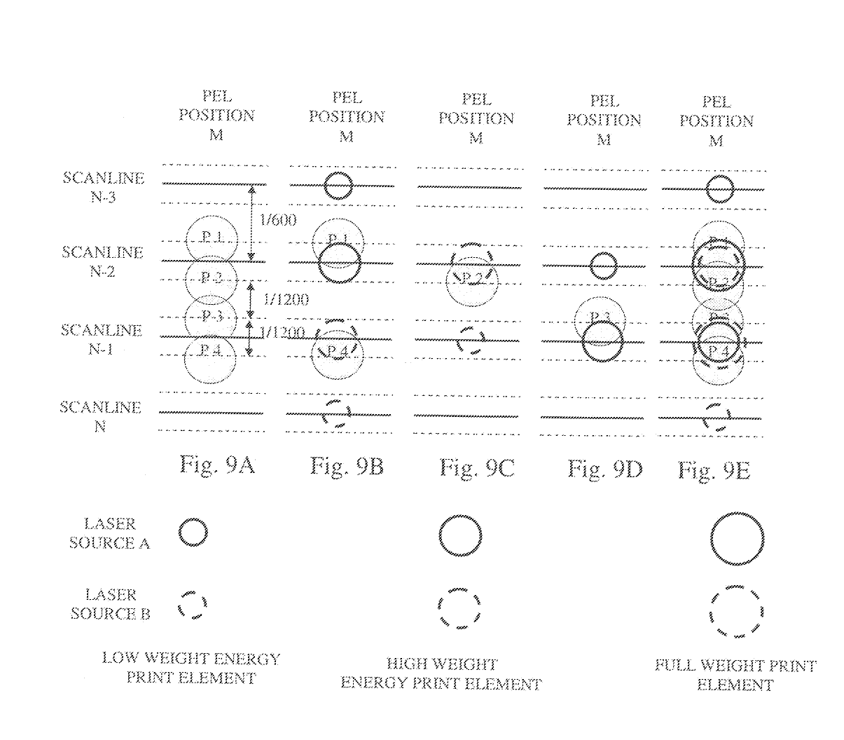

In the configuration illustrated in FIGS. 9A-9E, each laser source, e.g., laser source 18A and laser source 18B, is responsible for writing both components of each print element assigned to that laser source, in the illustrative example, laser source 18A is assigned all prim elements that axe to be synthesized in an upper lane of a corresponding scan line, and laser source 18B is assigned all print elements that are to be synthesized in a lower lane of a corresponding scan line, in this regard, each laser source 18A, 18B is calibrated so mat a full on prim element corresponds to the energy required to write a full print element. Each laser source 18A, 18B can also be modulated at least to an off state, a low weight energy state, e.g., ¼ power state and a high weight energy state, e.g., ¾ power state.

Referring to FIG. 9A, an illustrative set of scan lines show that for a given arbitrary print element positron, designated M, i.e., corresponding to an arbitrary column of prim elements on dm print substrate, it is desired to print four print elements, labeled P1, P2, P3 and P4, each spaced at 1200 dpi. As illustrated by the dashed lines, there is a “synthesized lane” 1/2400^{th} (10.58 micron) (above and below each natural scan line. Print element P1 is illustrated as being synthesized in the upper lane of scan line N-2. Print element P2 is illustrated as being synthesized in the lower lane of scan line N-2. Print element P3 is illustrated as being synthesized in the upper lane of scan line N-1. Further, print element P4 is illustrated as being synthesized in die lower lane of scan line N-1.

FIG. 9B illustrates the energy required to write print element P1 in the upper lane of scan line N-2. To write print element P1 in the upper lane of scan line N-2 at print element position M, laser source 18A is modulated on at ¼ power when writing to print element position M at scan line N-3 and laser source 18A is modulated on at ¾ power when writing to print element position M at scan line N-2. Laser source 18B is not utilised to write prim element P1.

Similarly, to write print element P4 in the lower lane of scan line N-1 at print element position M, laser source B is modulated on at ¾ power when writing to print element position M at scan line N-1 and laser source B is modulated on at ¼ power when writing to print element position M at scan line N. Laser source A is not utilized to write print element P4.

FIG. 9C illustrates the energy required to write print element. P2 in the lower lane of scan line N-2. To write print element P2 in the lower lane of scan, line N2 at print element position M, laser source B is modulated on at ¾ power when writing to print element position M at scan line N-2 and laser source B is modulated on at ¼ power when writing to print element position M at scan line N-1. Laser source A is not utilized to write print element P2.

FIG. 9D illustrates the energy required to write print element P3 in the upper lane of scan line N-1. To write print element P3 in the upper lane of scan line N-1 at print element position M, laser source 18A is modulated on at ¼ power when, writing to print element position M at scan line N-2 and laser source 18A is modulated on at ¾ power when writing to print element position M at scan line N-1. Laser source 18B is not utilized to write print element P3.

FIG. 9E shows the summation of energies required for each laser source 18A, 18B on each scan line. In the illustrative example, each laser source 18A, 18B is able to be able to modulate ON at two or more different energy levels. As shown, there are at least four levels per laser source 18A, 18B. Including off, low weight energy (e.g., ¼ power), high weight energy (e.g., ¾ power) and full on. However, other weighting arrangements may alternatively be implemented.

Given the above-described laser source capabilities, with reference to FIGS. 9A through 9E generally, it can be seen dun the column of print elements P1, P2, P3, P4 at print element position M can be realized as follows. On scan line N-3, laser source 18A is modulated ON at ¼ energy (corresponding to print element P1) and laser source 18B is modulated OFF at print element position M.

On scan line N-2, laser source 18A is modulated ON at % power for print element P1 and ¼ power for print element P4. As such, laser source 18A is modulated ON at full power at print element position M for scan line N-2. Laser source 18B is modulated ON at ¾ power corresponding to print element P3 at print element position M.

On scan line N-1 laser source 18A is modulated ON at ¾ power corresponding to print element P3 at print element position M. Laser source 18B is modulated ON at ¾ power for print element P4 and ¼ power for print element P2. As such, laser source 18B is modulated ON at full power at print element position M.

At scan line N, laser source 18A is modulated OFF at print element position M, and laser source 18B is modulated on at ¼ power corresponding to print element P4 at print element position M.

As described with reference to the present example, if a laser source is assigned to write a print element, that laser source writes both components of that prim element on adjacent scan lines.

For example, assume that both laser source 18A and laser source 18B can be modulated OFF or each laser source A, B can be modulated ON at a ¼ weight, ¾ weight or mil on. If print element slices are utilized to control the energy of the laser diodes and there are 6 slices per print element, then laser source 18A and 18B may each be modulated in one of at least four different states, including OFF (0/6 slices), low weight (2/6 slices), high weight (4/6 slices) or full on (6/6 slices). Alternatively, the different states may be represented by modulating the laser power of the laser sources or by using other suitable control techniques for varying the amount of energy delivered to the corresponding photoconductive surface.

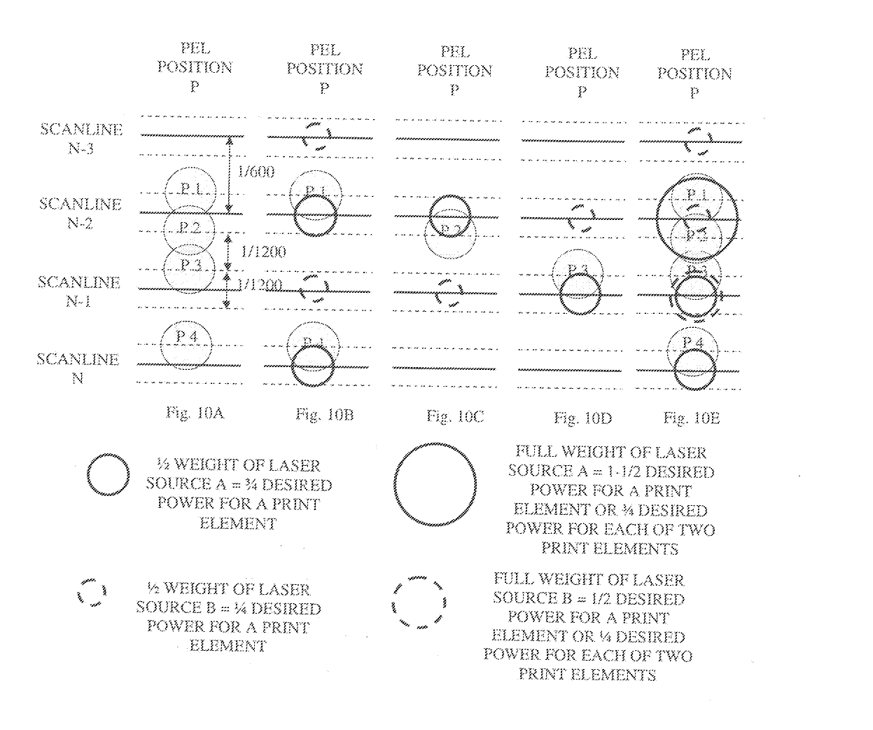

In an alternative embodiment, discussed below, each laser source may write a portion of each, print element. That is, if Pel synthesis is to be implemented, laser source 18A may write a first portion of the energy corresponding to a print element that is to be positioned in a synthesized lane and laser source 18B writes the remainder energy corresponding to that print element, and vice versa, an example of which is set out with reference to FIGS. 10A-10E.

As yet another example, keeping with the same exemplary apparatus, i.e., fixed beam scan spacing of 3/600th of an inch (127 microns) and a facet resolution of 600 dpi (236 dots per centimeter), the spacing of print elements may be controlled to realize full 1200 dpi resolution by utilizing some bask modifications to the above-described Pel synthesis approach. Again, the apparatus is calibrated such that laser beams from laser source 18A and laser source 18B overlap so as to realize 600 dpi (236 dots per centimeter) natural scan lines.

In the example illustrated with reference to FIGS. 10A-10E, each laser source 18A, 18B need at least three states including off, 50% or ½ weight and foil on or 100% weight. Assume that in the illustrative example, laser source 18A delivers the ¾ print element power and laser source 18B delivers the ¼ print element power. If print element slices are utilized to control the energy of dm laser sources 18A, 18B and there are 6 slices per print element, then laser sources 18A and 18B may each be in three different states, including OFF, 3/6 slices or 6/6 slices. Further, let the ½ power state (50% weight) of laser source 18A be calibrated to correspond to ¾ of the desired full energy of a print element, and that the ½ power state (50% weight) of laser source 18B be calibrated to correspond to hi of the desired bill energy of that print element. As shown, the second power level is generally twice the first power level. However, other weighting arrangements may alternatively be implemented.

As will be seen from the description below, the position of Print element P4 in FIGS. 10A, 10B and 10E is positioned in the upper lane of scan line N whereas print element P4 is shown in the lower lane of scan line N-1 in FIGS. 9A, 9B and 9E. This is done purely for illustrative purposes to clearly illustrate each of the three states for both laser source 18A and 18B in the present example.

Referring to FIG. 10A, the illustrative set of scan lines show that for a given arbitrary prim element position, designated P, i.e., corresponding to an arbitrary column of print elements on the print substrate, it is desired to print four print elements, labeled P1, P2, P3 and P4. Print element P1 is illustrated as being synthesized in the upper lane of scan line N2. Print element P2 is illustrated as being synthesized in die lower lane of scan line N2. Print element P3 is illustrated as being synthesized in the upper lane of scan line N-1. Further, print element P4 is illustrated as being synthesized in the upper lane of scan line N.

FIG. 10B illustrates the energy required to write print element P1 in the upper lane of scan line N-2. Also shown is the energy required to write print element P4 in the upper lane of scan line N. To write prim element P1 at print element position P, laser source 18B is modulated ON at ½ power and laser source 18A is correspondingly modulated OFF on scan line N-3 at print element position M. Correspondingly, laser source 18A is modulated on at ½ power and laser source 18B is modulated off at scan line N-2 at prim element position P. Because the ½ power of laser source 18A is calibrated to ¾ of the total print element energy, and the ½ power of laser source 18B is calibrated to ¼ of the total print element energy, a synthesized print element will be realized in the upper lane of scan line N-2.

To write print element P4 in the upper lane of scan line N at print element position P, laser source 18B is modulated ON at ½ power and laser source 18A is correspondingly modulated OFF on scan line N-1 at print element position M. Correspondingly, laser source 18A is modulated on at hi power and laser source 18B is modulated off at scan line A at print element position P.

FIG. 10C illustrates the energy required to write print element P2 in the lower lane of scan line N-2. To write print element P2 in the lower lane of scan line N2 at print element position P, laser source 18A is modulated ON at ½ power and laser source 18B is correspondingly modulated OFF on scan line N-2 at print element position M. Correspondingly, laser source 18B is modulated on at ½ power and laser source 18A is modulated off at scan line N-1 at print element position P.

FIG. 10D illustrates the energy required to write print element P3 in the upper lane of scan line N-1. To write print element P3 in the upper lane of scan line N-I at print element position P, laser source 18B is modulated ON at ½ power and laser source 18A is correspondingly modulated OFF on scan line N-2 at print element position M. Correspondingly, laser source 18A is modulated on at ½ power and laser source 18B is modulated off at scan line N-1 at prim element position P.

FIG. 10E shows the summation of energies required for each laser source 18A, 18B on each scan line. In the illustrative example, each laser source 18A, 18B is able to be able to modulate ON at two or more different energy levels. As shown, there are at least three levels per laser source 18A, 18B, including off, ½ energy (e.g., z power), and full on. However, other weighting arrangements may alternatively be implemented.

Given the above-described laser source capabilities, with reference to FIGS. 10A through 10E generally, it can be seen that the column of print elements P1, P2, P3, P4 at print element position P can be realized as follows. On scan line N3, laser source 18B is modulated ON at ½ energy (corresponding to prim element P1) and laser source 18A is modulated OFF at print element position P.

On scan line N-2, laser source 18A is modulated ON at 14 power for print element P1 and ½ power for prim element P2. As such, laser source 18A is modulated ON at foil power at print element position M for scan line N-2. Laser source 18B is modulated ON at ½ power corresponding to print element P3 at print element position P.

On scan line N-1 laser source 18A is modulated ON at ½ power corresponding to print element P3 at print element position M. Laser source 18B is modulated ON at ½ power for print element P4 and 14 power for print element P2. As such, laser source 18B is modulated ON at full power at print element position M.

At scan line N, laser source 18A is modulated on at ½ power for print, element P4 and laser source 18B is modulated off at print element position M.

The above examples are merely illustrative and other combinations may be utilized, depending upon the desired design goals. Also, although described with reference to a 3/600 dpi beam scan spacing and 600 dpi and 1200 dpi synthesized print modes, other combinations may be implemented with minor modifications to the described values. Also, while described with reference to two synthetic lanes, other numbers of lanes may be implemented, depending upon the specific printing requirements. Still further, any number of weights associated with each laser source may be utilized, and the particular values of those weights relative to the desired energy per print element written to the photoconductive surface may vary from the examples described in greater detail herein. Still further, the weights assigned to each laser source may be different from one another.

The description herein describes scan lines that “overlap”. The term “overlap” should be interpreted expansively to comprehend not only ideally registered scan lines, but also to includes implementations where the laser beam scan paths from the first and second laser sources do not exactly line up, e.g., due to inaccuracies in calibrating the beam scan spacing anchor due to inaccuracies in establishing the rotational velocity of the photoconductive surface, velocity of the scanner, etc. Also, scan, lines overlap as defined herein, even if print elements do not precisely register due to skew, bow, margin, placement, scan line print element placement errors and other process and scan direction position errors, which may be caused, for example, by the effects of temperature, imperfections in the optics system, imprecisely calibrated electronics, etc.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that die terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to die invention in the form disclosed. Many modifications and variations wilt be apparent to those of ordinary skill in the art without departing from the scope and spirit of the invention.

Having thus described the invention of the present application in detail and by reference to embodiments thereof, it will be apparent that modifications and variations are possible without departing from the scope of the invention defined in the appended claims.

What is claimed is:

1. An electrophotographic device comprising:
a first laser source controllable to emit a first, laser beam;
a second laser source controllable to emit a second laser beam;
a scanning device having a plurality of deflecting surfaces arranged to direct said first and second laser beams so as to sweep in a scars direction across a photoconductive surface such that, for each sweep, a scan line written on said photoconductive surface by said first laser beam is spaced in a process direction that is orthogonal to said scan direction from a scan line written by said second laser beam by a predetermined beam scan spacing; and
a controller configured to control said electrophotographic device to provide at least one print mode wherein:
said electrophotographic device is controlled such that sears lines written by said first laser beam overlap with scan lines written by said second laser beam; and
a laser power of said first laser source and a laser power of said second laser source are controlled such that image data corresponding to select print elements are each partially written at a corresponding print element position along at least two adjacent scan lines so as to combine energy in a manner that forms a synthesized print element on said photoconductive surface at a position between said adjacent scan lines.

2. The electrophotographic device according to claim 1, wherein:
each synthesized print element is written by a select one of said first and second laser sources.

3. The electrophotographic device according to claim 1, wherein:
each synthesized print element is written by the combined energy of said first and second laser sources.

4. The electrophotographic device according to claim 1, wherein:
each synthesized print element can be selectively positioned in one of two synthesized positions including a first synthesized position above a corresponding natural scan line and a second synthesized position below said corresponding natural scan line;
said first laser source writes energy on adjacent scan lines corresponding to synthesized print elements to be positioned in said first synthesized position; and
said second laser source writes energy on adjacent scan lines corresponding to synthesized print elements to be positioned in said second synthesized position.

5. The electrophotographic device according to claim 1, wherein each of said first and second laser sources can be modulated ON at a select one of at least two different energy levels.

6. The electrophotographic device according to claim 5, wherein:
each synthesized print element can be selectively positioned in one of two synthesized positions including a first synthesized position above a corresponding natural scan line and a second synthesized position below said corresponding natural, scan line;
said first and second synthesized positions are selected so as to achieve double the image resolution of what is otherwise achieved by adjacent natural scan lines; and
a first one of said energy levels is weighted differently from a second one of said energy levels for each of said first and second laser sources so that each synthesized print element is realized in an intended one of said first or second synthesized positions.

7. The electrophotographic device according to claim 1, wherein:
said at least one print mode comprises a spacing between adjacent scan lines such that said beam scan spacing is an integer multiple of said spacing between said adjacent scan lines; and
further comprising at least one additional print mode wherein said beam scan spacing is not an integer multiple of said spacing between said adjacent scan lines.

8. A method of controlling an electrophotographic device comprising:
controlling a first laser source to emit a first laser beam;
controlling a second laser source to emit a second laser beam;
controlling a scanning device having a plurality of deflecting surfaces arranged to direct said first and second laser beams so as to sweep in a scan direction across a photoconductive surface such that, for each sweep, a scan line written cm said photoconductive surface by said first laser beam is spaced in a process direction that is orthogonal to said scan direction from a scan line written by said second laser beam by a predetermined beam scan spacing; and
providing at least one print mode comprising:
controlling said electrophotographic device such that scan lines written by said first laser beam overlap with scan lines written by said second laser beam; and
controlling a laser power of said first laser source and a laser power of said second laser source such that image data corresponding to select print elements are each partially written at a corresponding print element position along at least two adjacent scan lines so as to combine energy in a manner that forms a synthesized print element on said photoconductive surface at a position between said, adjacent scan lines.

9. The method according to claim 8, wherein said controlling a laser power of said first laser source and a laser power of said second laser source such that image data corresponding to select print elements are each partially written at a corresponding print element position along at least two adjacent scan lines so as to combine energy in a manner that forms a synthesized print element on said photoconductive surface at a position between said adjacent scan lines comprises;
controlling said laser power of said first and said second laser sources such that each synthesized print element is written by a select one of said, first and second laser sources.

10. The method according to claim 8, wherein said controlling a laser power of said first laser source and a laser power of said second laser source such that image data corresponding to select print elements are each partially written at a corresponding print element position along at least two adjacent scan lines so as to combine energy in a manner that forms a synthesized print element on said photoconductive surface at a position between said adjacent scan lines comprises:
controlling said laser power of said first and said second laser sources such that each synthesized print element is written by the combined energy of said first and second laser sources.

11. The method according to claim 8, wherein said controlling a laser power of said first laser source and a laser power of said second laser source such that image data corresponding to select print elements are each partially written at a corresponding print element position along at least two adjacent scan lines so as to combine energy in a manner that forms a synthesized print element on said photoconductive surface at a position between said adjacent scan lines further comprises:
selectively positioning each synthesized print element in one of two synthesized positions including a first synthesized position above a corresponding natural scan line and a second synthesized position below said corresponding natural scan line by:
using said first laser source to write energy on adjacent scan lines corresponding to synthesized print elements to be positioned in said first synthesized position; and
using said second laser source to write energy on adjacent scan lines corresponding to synthesized print elements to be positioned in said second synthesized position.

12. The method according to claim 8, wherein said controlling a laser power of said first laser source and a laser power of said second laser source further comprises:
controlling said first and second laser sources such that said laser power can be modulated ON at a select one of at least two different energy levels.

13. The method according to claim 12, further comprising:
selectively positioning each synthesized print element in one of two synthesized positions including a first synthesized position above a corresponding natural scat) line and a second synthesized position below said corresponding natural scan line;
selecting said first and second synthesized positions so as to achieve double the image resolution of what is otherwise achieved by adjacent natural scars lines; and
weighting a first one of said energy levels differently from a second one of said energy levels for each of said first and second laser sources so that each synthesized print element is realized in an intended one of said first or second synthesized positions.

14. The method according to claim 8, wherein said at least one print mode further comprises:
setting a spacing between adjacent scan lines such that said beam scan spacing is an integer multiple of said spacing between said adjacent scan lines; and
further comprising providing at least one additional print mode wherein said beam scan spacing is not an integer multiple of said spacing between said adjacent scan lines.

15. A method of using dual laser sources to write image data to a photoconductive surface comprising:
assigning at least a first weight and a second weight, each comprising a fraction of a desired full power print element to a first laser source;
assigning at least a first weight and a second weight, each comprising a fraction of said desired full power print element to a second laser source;
controlling an imaging operation of an electrophotographic device such that said first and second laser sources overlap scan lines when writing to a corresponding photoconductive surface; and
controlling said first and second laser sources such that image data corresponding to select print elements to be written to said photoconductive surface are each partially written at a corresponding print element position along at least two adjacent scan lines so as to combine energy in a manner that forms a synthesized print element on said photoconductive surface at a position between said adjacent scan lines.

16. The method according to claim 15, wherein said assigning at least a first weight and a second weight comprises;
selecting said first weight and said second weight for each of said first and second laser sources to define two synthetic lanes, a first synthetic lane above a natural scan line and a second synthetic lane below said natural scan line.

17. The method according to claim 15, wherein said controlling said first and second laser sources such that image data corresponding to select print elements to be written to said photoconductive surface are each partially written at a corresponding print element position along at least two adjacent scan lines so as to combine energy in a manner that forms a synthesized print element on said photoconductive surface at a position between said adjacent scan, lines, further comprises:
controlling said first and said second laser sources such that each synthesized print element is written by a select one of said first and second laser sources.

18. The method according to claim 15, wherein said controlling said first and second laser sources such that image data corresponding to select print elements to be written to said photoconductive surface are each partially written at a corresponding print element position along at least two adjacent scan lines so as to combine energy in a manner that forms a synthesized print element on said photoconductive surface at a position between said adjacent scan lines, further comprises:
controlling said first and said second laser sources such that each synthesized print element is written by a select one of said first and second laser sources.

19. The method according to claim 15, further comprising:
selectively positioning each synthesized print element in one of two synthesized, positions including a first synthesized position above a corresponding natural scan line and a second synthesized position below said corresponding natural scan line;
selecting said first and second synthesized positions so as to achieve double the image resolution of what is otherwise achieved by adjacent natural scan lines; and
setting said first weight differently from said second weight for each of said first and second laser sources so that each synthesized print element is realized in an intended one of said first or second synthesized positions.

20. The method according to claim 18, wherein said controlling said first and second laser sources such that image data corresponding to select pint elements to be written to said photoconductive surface are each partially written at a corresponding print element position along at least two adjacent scan lines so as to combine energy in a manner that forms a synthesized print element on said photoconductive surface at a position between said adjacent scan lines, further comprises:
utilizing a scanning device having a plurality of deflecting surfaces arranged to direct said first and second laser beams so as to sweep in a scan direction across a photoconductive surface such that, for each sweep, a scars, line written on said photoconductive surface by said first laser beam is spaced in a process direction that is orthogonal to said scan, direction from a scan line written by said second laser beam by a predetermined beam scan spacing; and
controlling said first and second laser sources to create synthesized, print element positions realized on said photoconductive surface that represents an effective beam scan spacing between said first laser source and said second laser source that is different from said predetermined beam scan spacing.

21. The method according to claim 18, further comprising:
establishing at least two different weights when said first laser source is modulated on;
establishing at least two different weights when said second laser source is modulated on;
modulating said first laser source on at a first one of said at least two different weight if contributing energy to a single synthesized print element and at a second one of said at least two different weights if contributing energy to two synthesized print elements; and
modulating said second laser source on at a first one of said at least two different weight if contributing energy to a single synthesized print element and at a second one of said at least two different weights if contributing energy to two synthesized print elements.
